(19) United States
(12) Patent Application Publication
(10) Pub. No.: US 2025/0253671 A1
(43) Pub. Date: Aug. 7, 2025

(54) MANAGING ENERGY SOURCES IN A POWER GRID

(71) Applicant: Saudi Arabian Oil Company, Dhahran (SA)

(72) Inventors: Rafat Rob, Dhahran (SA); Khaled F. Alotaibi, Al-Doha (SA); Dana Nour, Dhahran (SA); Abdulmohsen Mulhim, Dammam (SA); Mazen Aldoal, Dhahran (SA)

(21) Appl. No.: 18/432,744

(22) Filed: Feb. 5, 2024

(51) Int. Cl. H02J 3/46; G06Q 50/06; H02J 3/00

(52) U.S. Cl. CPC H02J 3/46; G06Q 50/06; H02J 3/003; H02J 2300/28

(57) ABSTRACT

Example implementations of managing a power grid include identifying a plurality of energy generation resources electrically coupled within a power grid; identifying at least one renewable energy source within the plurality of energy generation resources electrically coupled within the power grid; inputting grid and energy source data from the identified plurality of energy generation resources into the energy dispatch model; executing an optimization algorithm with the energy dispatch model to optimize at least one objective function; determining at least one energy system control command based on the executed optimization model; and controlling the plurality of energy generation resources to maximize a power output of the at least one renewable energy source based on the executed energy dispatch model.

### TECHNICAL FIELD

The present disclosure describes systems and methods associated with managing energy sources in a power grid and, more particularly, managing energy sources in a power grid by dynamically controlling renewable energy with an energy production model that utilizes an objective problem optimization methodology to maximize the utilization of renewable energy.

### BACKGROUND

There are many challenges that developing countries face when it comes to renewable energy integrations. Challenges include increase in electricity tariffs, obstruction when constructing substations, load shedding, unpredictable outages due to complex frequency regulations, and foremost environmental apprehension. Comparatively, more developed countries especially during early stages of renewable energies integration, face difficulties in different, but just as important, areas. Developed countries were overwrought about a speedy integration of new renewable resources that they skipped some of the required studies, analysis, and some of the regulations necessary to maximize the benefits of the new technologies for running a safe and secure energy production operation.

### SUMMARY

Example implementations according to the present disclosure can be realized in computer-implemented methods, computer systems that include one or more hardware processors and one or more memory modules, and tangible, non-transitory computer readable media. Example implementations of managing a power grid include identifying a plurality of energy generation resources electrically coupled within a power grid; identifying at least one renewable energy source within the plurality of energy generation resources electrically coupled within the power grid; inputting grid and energy source data from the identified plurality of energy generation resources into the energy dispatch model; executing an optimization algorithm with the energy dispatch model to optimize at least one objective function; determining at least one energy system control command based on the executed optimization model; and controlling the plurality of energy generation resources to maximize a power output of the at least one renewable energy source based on the executed energy dispatch model.

In an aspect combinable with the example implementation, the operation of controlling the multiple energy generation resources to maximize the power output of the at least one renewable energy source based on the executed energy dispatch model includes controlling the multiple energy generation resources to minimize curtailment of the at least one renewable energy source based on the executed energy dispatch model.

In another aspect combinable with any of the previous aspects, the at least one renewable energy source includes a wind energy source.

In another aspect combinable with any of the previous aspects, the energy dispatch model includes an IEEE RTS 24-Bus model.

In another aspect combinable with any of the previous aspects, the operation of executing the optimization algorithm with the energy dispatch model to optimize at least one objective function includes executing the optimization algorithm with the energy dispatch model to minimize an operational cost function; and executing the optimization algorithm with the energy dispatch model to maximize a usage of the at least one renewable energy source function.

In another aspect combinable with any of the previous aspects, the operational cost function includes a thermal energy operational cost function, a renewable energy operational cost function, and an emissions operational cost function.

In another aspect combinable with any of the previous aspects, the grid and energy source data include wind forecast systems data, auto load forecast data, distributed wind energy data, thermal energy generation data, auxiliary energy generation data, and aggregated energy generation data.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an energy dispatch model according to the present disclosure.

FIG. 2 is a flowchart that illustrates an example energy dispatch model method according to the present disclosure.

FIG. 3 is an illustration of graphs that show energy market renewable prices.

FIG. 4 is an illustration of an energy market with negative energy prices.

FIG. 5 is another illustration of an energy market with negative energy prices.

FIG. 6 is an illustration of a graphic of energy production by energy source type.

FIG. 7 is an illustration of an energy market integration model.

FIG. 8 is an illustration of a graph of renewable energy source curtailment in a power grid over time.

FIG. 9 is an illustration of a graph of wind energy source curtailment in a power grid over time.

FIG. 10 is an illustration of a graph of solar energy source curtailment in a power grid over time.

FIG. 11 is an illustration of an example implementation of an energy dispatch model using the IEEE RTS 24-Bus model according to the present disclosure.

FIG. 12 is a chart that illustrates coefficients and parameters of the energy dispatch model using the IEEE RTS 24-Bus model according to the present disclosure.

FIG. 13 is a chart that illustrates an output of an optimal energy dispatch algorithm with renewable energy source integration independent of objective function optimization according to the present disclosure.

FIG. 14 is a chart that illustrates an output of an optimal energy dispatch algorithm with renewable energy source integration including objective function optimization according to the present disclosure.

FIG. 15 is a chart that illustrates generation rebalance values to maximize wind generation and minimize wind curtailment based on the outputs of FIGS. 13 and 14 according to the present disclosure.

FIG. 16 shows a schematic drawing of a control system that can be used to build and execute an energy dispatch model according to the present disclosure and/or any processes described in the present disclosure.

### DETAILED DESCRIPTION

The present disclosure describes example implementations of computer-implemented methods, systems, and computer readable media that execute a dynamic-adaptive multi objective dispatch model to address a highly renewable penetration grid in an energy market with predetermined obligation requirements. The example implementations of the dispatch model take into considerations a high volume of renewable energy to reduce energy price with the constraints of having enough energy resources available to maintain system reliability by ensuring a continuous supply of energy in a case of a renewable interruption. The dispatch model integrates thermal/classical power plants with renewable (e.g., wind and solar) generation to represent the whole grid operation. In example aspects, a multi-objective optimization method is implemented with the dispatch model to encompasses optimization theory by allowing each single objective to be minimized-cost or maximized-renewable use. The dispatch model allows for a maximization of the renewable resources with minimal curtailment to eliminate or reduce monetary fines for curtailment or if renewable energy obligations are not met.

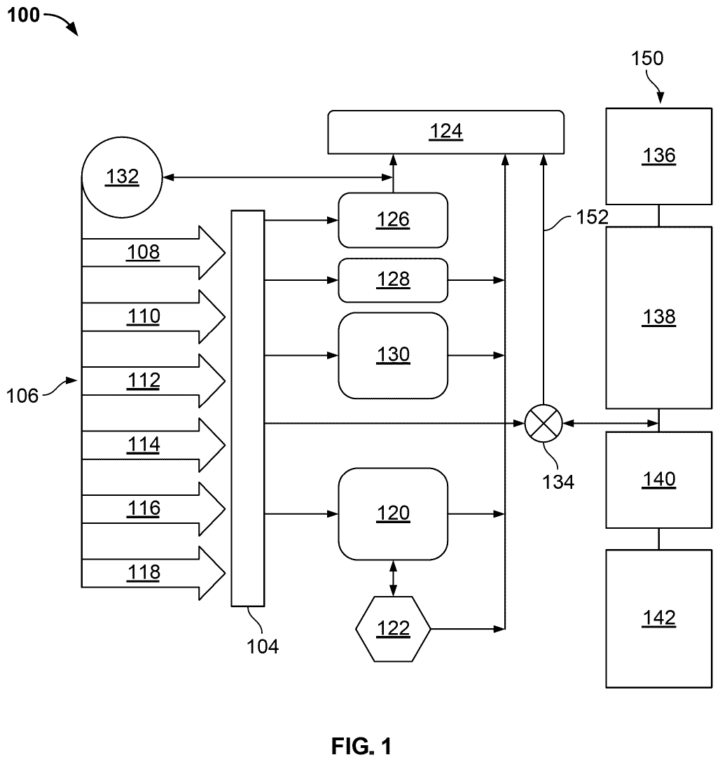

FIG. 1 is a schematic diagram of an energy dispatch model 100 according to the present disclosure. In this example implementation, the energy dispatch model 100 includes an input model 104 that includes multiple inputs 106 and feeds into, among other components, a real time energy market model 120 and a power grid model 122. The inputs 106, in this example, include wind forecast systems data 108, auto load forecast data 110, distributed wind energy data 112, thermal energy generation data 114, auxiliary energy generation data 116, and aggregated energy generation data 118. The inputs 106 are fed into the real time energy market model 120 and the power grid model 122, as well as a day ahead optimization model 126, a convergence bidding model 128, and a security constrained economic dispatch 130. The models 120 through 130 are fed to an energy management system 124 that controls a power grid. System errors 132 are accounted for in the inputs 106 and at the energy management system 124.

The inputs 106 and models 128, 130, and 120 are also fed into a processor 134 that also executes an optimization module 150 to provide control command 152 to the energy management system 124 for control of one or more energy generation systems (e.g., wind, solar, thermal/hydrocarbon) by the energy management system 124. The optimization module 150 includes a mathematical form of a dynamic economic dispatch 136, an optimal dispatch algorithm 138, and cost function objectives 140 and 142. Cost function objective 140 is a minimization of renewable energy curtailment, while cost function objective 142 is a minimization of a non-linear thermal power dispatch.

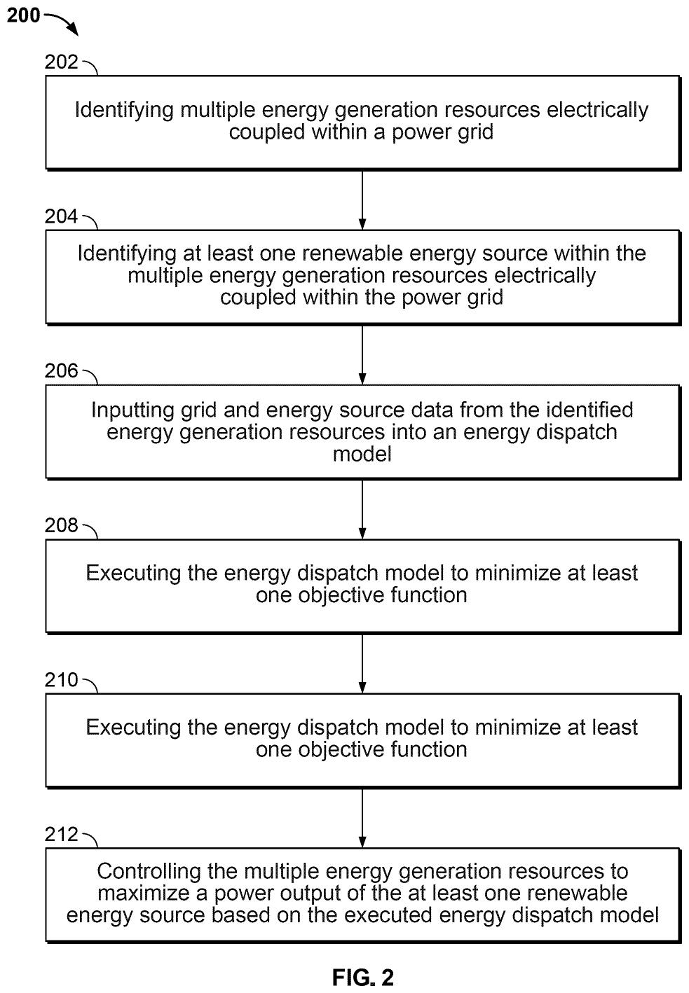

FIG. 2 is a flowchart that illustrates an example energy dispatch model method 200 according to the present disclosure. Method 200 can begin at step 202, which includes identifying multiple energy generation resources electrically coupled within a power grid. For example, am electrical power grid (or power grid) can include multiple different types of energy generation resources, including renewable and non-renewable resources. And the electrical power grid is just a part of a wholesale energy market (or which there can be many, divided according to geopolitical divisions in some cases).

The wholesale energy markets are managed and controlled by a Independent System Operator (ISO) or similar grid operators. ISOs can be totally independent, nonprofit, federally regulate, manages and harmonizes regional transmission to guarantee non-discriminatory access to the electric grid. The ISO is based on a public benefit corporation to maintain power delivery to communities and the electrical power industry. The concept of non-owner grid operators was molded by the Federal Energy Regulatory Commission (FERC) to enforce generator owners, transmission line owners and utilities to work together with FERC guidelines and rulings to ensure fair treatment while using the non-utility owned, transmission lines, or power plants.

A Regional Transmission Organizations (RTO) is very similar to ISO with one difference, it covers a larger geographic area than an ISO. In the U.S., for example, the ISOs, RTOs, and the regulated energy market represent the majority of the U.S. grid operation, but there are few energy markets that is managed vertically by the utilities and their transmission owners.

ISOs and RTOs can represent the ultimate authority, control, and final say when it comes to power generation dispatch to preserve reliability, stability, and optimization and efficiency. ISOs and RTOs control and oversee transmission tariffs and payments for energy. This way, the availability of ancillary services is secured and information regarding the condition of energy transmission and accessible transmission capacity is readily available.

Method 200 can continue at step 204, which includes identifying at least one renewable energy source within the multiple energy generation resources electrically coupled within the power grid. For example, to safeguard and guarantee a successful and safe renewable integration, a geopolitical unit (e.g., a country) may need to manage its own renewable integration by taking into consideration the need for a renewable blend, grid infrastructure, geographic diversity and current grid code. Governing agencies in each unit can work closely with stakeholders, utilities and research entities to secure and make sure the renewable development and integration of renewable energy resources align with the classical grid. This can be essential to achieve flexibility, efficiency, reliability and safety. In the absence or no enforcement of regulations, inadequate grid code, and lack of understanding of the consequences of such approach, allowed many renewable projects to go online prematurely. As a result, some of the approaches by stakeholders towards renewable integration have been proven to be insufficient to support a sustainable renewable development.

Indeed, renewable energy has changed the wholesale energy market strategy and created new realities (e.g., undesirable) for the grid operators, especially when renewable contribution has exceeded 15% of the supplied power. When the landscape of a wholesale energy market demands major changes to day-ahead and real-time electricity market, ISOs are obligated to make policy changes to stabilize and balance the generation and demand side. Day-ahead and real-time now must deal with the real risk of overgeneration, which can result in negative prices almost on a daily basis. This was not the case in the past: conventional generation can be easily controlled and in no way intermittent.

Because of overgeneration and/or intermittency, some of the challenges facing developing countries when it comes to renewable integrations is not having reliable resources and lack of reliable process to accomplish the following tasks: (1) Tolerate and Endure Fast Ramps in Both Directions Reliably and the Ability to Switch Directions within a Very Short Time Frame; (2) The Ability and Capability to Withstand the Response for A Predetermined Interval of Time; (3) The ability to store produced energy onsite and ready to use it when required; (4) Storing over generated power and using storage energy to support AGC; (5) The ability to start, stop, and curtail within short notice; (6) Withstand the frequent start, stop, pause, and go offline many times per day; (7) Build a strong precise operational forecasting system; and (8) Create Reliable Renewable Resources.

An example model of an energy market includes, e.g., two markets: day-ahead and real-time markets. Owners and customers submit bids and offers to exchange energy for payment. This is not the only available model, and there are more sophisticated models of energy market where owners and customers can take advantage of other concepts. These market models include an incremental energy market, a no-load cost energy market (e.g., operation at the minimum generation level or zero lever (spinning generation), and off-line cost for starting up the generating and synchronization with grid (non-spinning generation).

Renewable resources owners who want to place energy market bids need to compete with classical market models such as bids such as Unit Constraints, Generation Ramp time to reach the grid needs, Online Commitments, and physical operational constraints. One example primary objective is the market convergence—it is beneficial as it discourages market participants to have any preference or inclination to stay in one specific market and not join other markets. Energy bids deliver an economic signal representing a participant's willingness to supply or purchase energy.

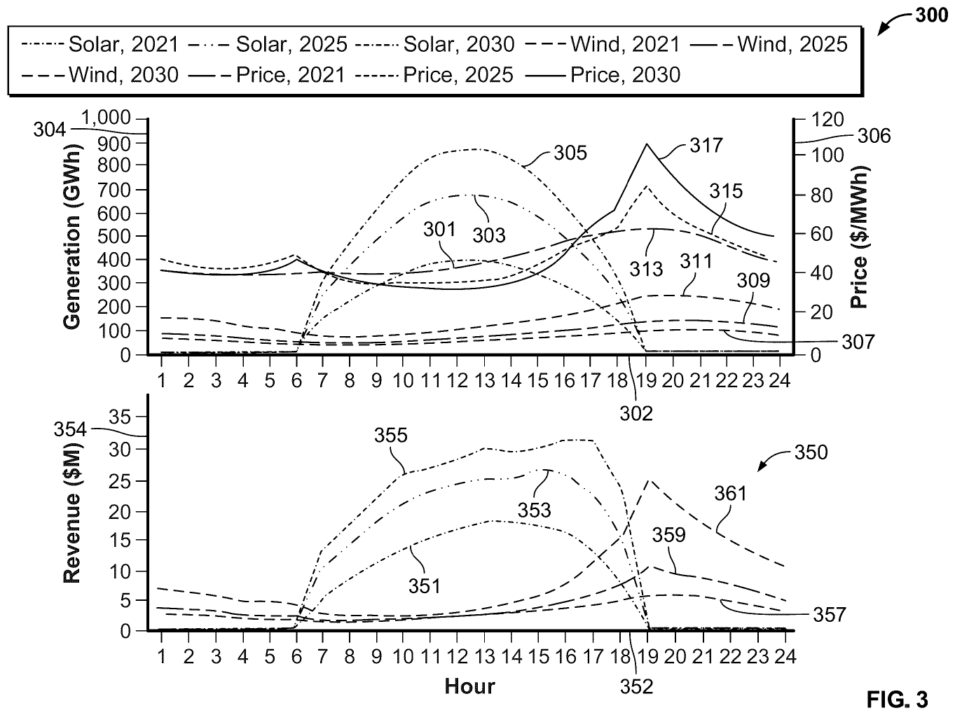

For example, FIG. 3 is an illustration of graphs 300 and 350 that show energy market renewable prices. Graph 300 reflects California renewable source generation (on y-axis 304, in GWh) and renewable source price (on y-axis 306, in $ per MWh) over time in a 24 hour period in August (on x-axis 302, in hours). Curves 301, 303, and 305 reflect solar generation while curves 307, 309, and 311 reflect wind generation. Curves 313, 315, and 317 reflect price. Curves 301, 307, and 313 reflect year 2021; curves 303, 309, and 315 reflect year 2025; and curves 305, 311, and 317 reflect year 2030.

Graph 350 reflects California renewable source revenue (on y-axis 354, in millions of USD) over time in a 24 hour period in August (on x-axis 352, in hours). Curves 351, 353, and 355 reflect solar generation while curves 357, 359, and 361 reflect wind generation. Curves 351 and 357 reflect year 2021; curves 353 and 359 reflect year 2025; and curves 355 and 361 reflect year 2030.

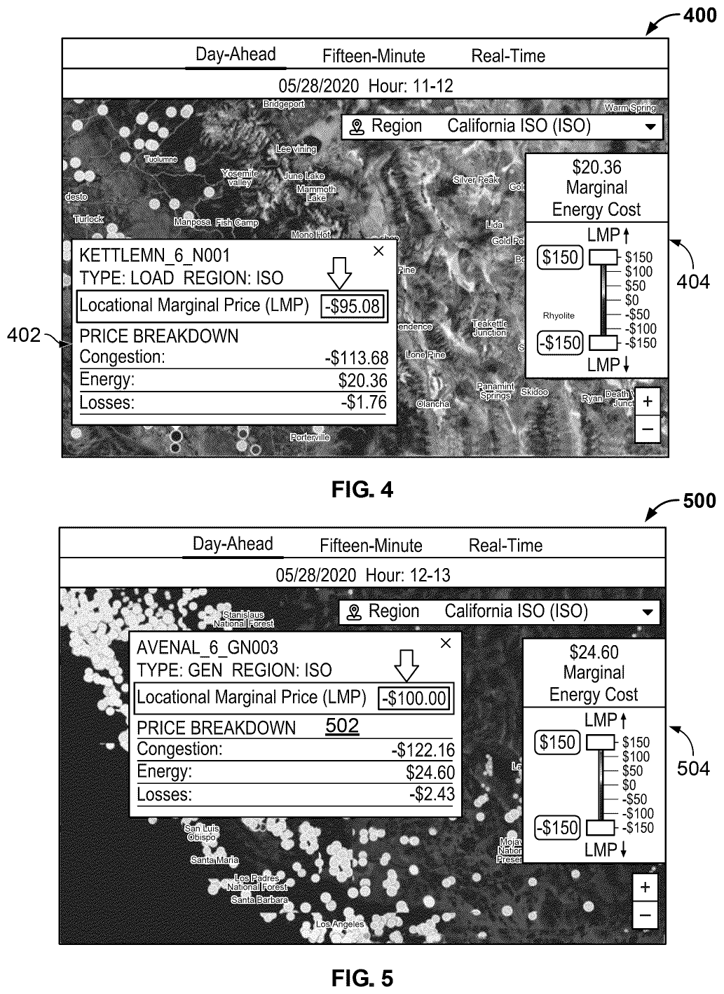

However, power grids in developing countries can collapse due to over renewable generation, which can halt any meaningful advancements in renewables (e.g., especially wind energy). Developed countries with mature ISOs can deal much better with the situations such as greater generation than demand, as the extra electricity must be dealt with to maintain the stability of the system. The more renewable energy production, the more likely the electricity prices will be negative; this is becoming a reality for the ISOs. As described, the process of controlling these fluctuations is not a straight-forward task and can be difficult to manage in an automated manner. Renewable contribution can, in fact, damage the grid reliability and stability if not managed appropriately. Currently, grid operators contend with the overgeneration using old techniques and methods, such as a manual techniques of switching the automatic control off. Overgeneration caused by renewable resources has created a phenomena in the energy market pricing category of negative price for electricity. Generator owners and energy suppliers are paying the utilities to take extra generated energy off their hands because they cannot find anyone to purchase it. For example, FIG. 4 is an illustration 400 of an energy market (e.g., in California) with negative energy prices. Here, as shown in box 402, a negative energy price of −$95.08 has occurred while box 404 shows a positive marginal energy cost of $20.36. Similarly, FIG. 5 is another illustration 500 of an energy market with negative energy prices. Here, as shown in box 502, a negative energy price of −$100.00 has occurred while box 504 shows a positive marginal energy cost of $24.60.

Grid operators can balance a power grid by taking unprecedented actions such as fully shutting down generation resources instantly or bringing generation resource online instantly. Generator ramps may be swiftly running in such a short time, or the real time and convergence energy market might collapse with great financial losses for both energy suppliers and load owners.

Stabilizing grid frequency with less conventional generation can be difficult: the automatic generation controllers cannot adjust fast enough when renewable presence is high because of the reduction of the resources that are capable to automatically regulate electricity production to sustain grid reliability. Wind power plants generation can be challenging for system operators, utilities, protection engineers and consumers. Some of the major issues identified are; variability, intermittency, partial controllability, location, power quality, system security, and stability. Wind power contribution is considered as one of the main sources of new renewable energy, but with it comes more work to maintain and operate. Mature ISOs can shift the market to renewable by avoiding the negative perception toward the collapsing prices of energy at the peak of energy.

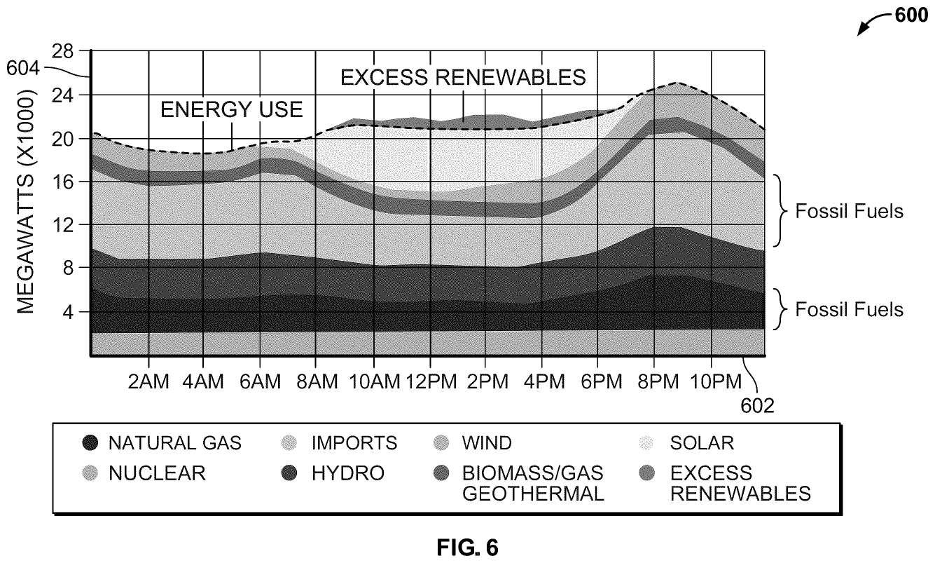

For example, FIG. 6 is an illustration of a graphic 600 of energy production by energy source type, which can explain this incorrect understanding. For instance, graph 600 shows power generation by power source and, due to the generation of renewables, create a perception of “excess” renewables. Graph 600 includes x-axis 602 (of time of day, by hour) and y-axis 604 (of megawatts×1000). Due to this perception of “excess” renewable energy, there is a perception that curtailment of renewables is warranted. For example, renewable energy curtailment in California is in a dilemma for serious and significantly wind curtailment, which can cause a loss of the opportunity to use clean energy. California is the best example of how issues can get more complicated when renewable energy is integrated into the energy market.

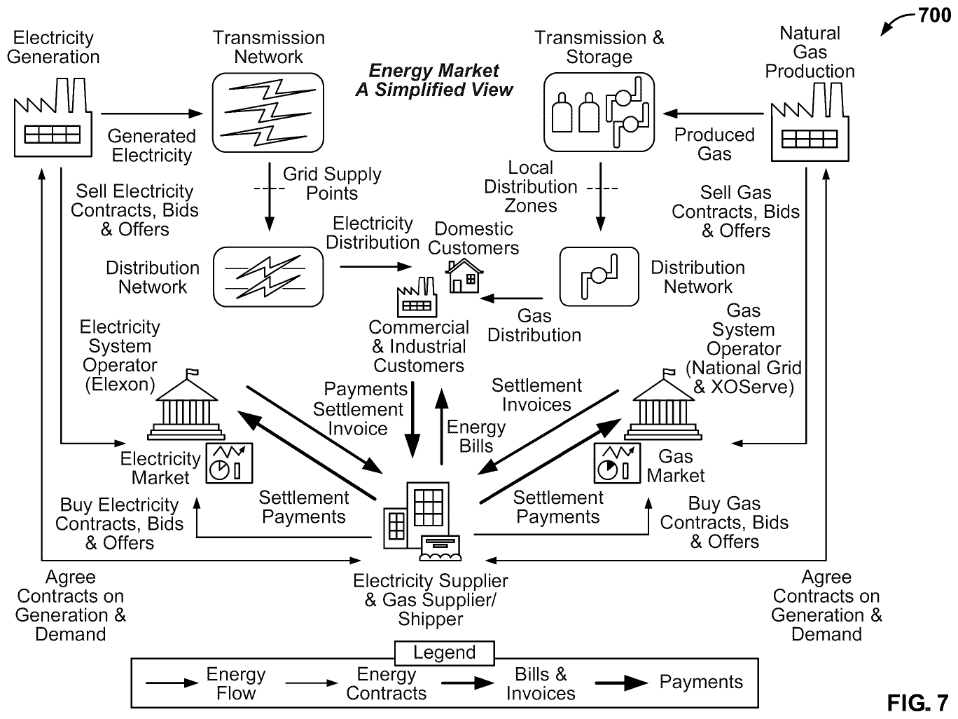

Introducing new generation resources can require careful planning to address every aspect of the power grid. Planning can include the three stages of System Impact Studies, Short Circuit analysis, Power Flow and System Stability. These studies can demonstrate the viability of the new integration. The planning aspect must include assessing the Power System Operations side of the renewable integration. The entire generation fleet of power plants may need to perform as expected at different time frames; daily, hourly, minutes and seconds. The power grid should be balanced at all times to ensure a reliable operation. Reactive and active power should be balanced at all times as well. Wind power plants are not dispatchable in the same way as thermal generation plants. For this reason, the grid should be able to consume all of the power produced. The classical generation sources can be flexible to adjust its output, to accommodate power from the wind plant. In essence, planning prior to any renewable energy projects is a very essential aspect. The planning phase includes various system impact studies, especially for wind farms integration. For example, FIG. 7 is an illustration of a graphic 700 of energy production by energy source type. Graphic 700 summarizes the best energy market integration model.

Grid operators can balance the grid by taking actions such as fully shutting down generation resources instantly or bringing generation resource online instantly. Generator ramps can be swiftly running in such a short time, or the real time and convergence energy market might collapse with great financial losses for both energy suppliers and load owners. Stabilizing grid frequency with less conventional generation can be difficult: The Automatic Generation Controllers may not adjust fast enough when the renewable presence is high because of the reduction of the resources that are capable to automatically regulate electricity production to sustain grid reliability. Renewables integration requires good modeling, oscillation mitigation and transmission management. Dynamic Line Loading for greater throughput without more capital investment. Baselining for understanding “Normal” and discovering new potential problems. Islanding for electrical island detection and blackout restoration.

Protection for automated system protection operations can provide for the following points: (1) Tolerate and Endure Fast Ramps in Both Directions Reliably and the Ability to Switch Directions within a Very Short Time Frame; (2) The Ability and Capability to Withstand the Response for A Predetermined Interval of Time; (3) The ability to store produced energy onsite and ready to use it when required; (4) Storing over generated power and using storage energy to support AGC; (5) The ability to start, stop, and curtail within short notice; (6) Withstand the frequent start, stop, pause, and go offline many times per day; and (7) Build a strong precise operational forecasting system.

Variable renewable resources can consider securing and acquiring ancillary services. The unpredictability, variability randomness, and uncertainty of renewable resources must improve the regulations, apply stricter standards, and create newer and firmer requirements for several ancillary services, taking into consideration the more expensive services. Further, the bigger footprint of solar and wind has the potential to impact the grid negatively and alter the grid conditions faster than any previous generation resources. This can make it difficult for ancillary services to fulfill the demand when needed. Further, variable renewable resources can be used as a provider of ancillary services, but it also can backfire because it is very challenging due to the characteristics of these resources.

Method 200 can continue at step 206, which includes inputting grid and energy source data from the identified energy generation resources into an energy dispatch model. For example, as the preceding discussion shows, there is significant data related to the power grid as well as specific energy source generators. For instance, data such as power generation per hour per source, cost to generate, price per power unit generated (in real time or next day) can all be input into the energy dispatch model.

Other data can also be included and accounted for in the energy dispatch model. For example, load forecast errors are considered in the energy dispatch model, which can be critical to allow a small perturbation and keep it as a byproduct of the normal distribution calculations and normalizations. This supposition can be used for the day-ahead and hour-ahead energy market timetables, which is normally used to signify the economic dispatch and the unit commitment timeframes. Day-ahead, for example, can depend heavily on the load forecasts.

Some ISOs have implemented Auto Load Forecast Systems (ALFS). Electrical grid operations use ALFs with the application of unit commitment process to govern the slow and time-consuming thermal power plants to start during the hours of day ahead market. Any error in the load forecast might cause a suboptimal condition and effect the commitment power generation in the day-ahead market. In particular aspects, applying singular perturbation theory to acquire and attain a simplified electrical grid model for system study, stability, analysis and controller design can be implemented in the energy dispatch model. The energy dispatch model can also allow system perturbation, but may not allow disturbances of external inputs because calculations in the optimization steps can be corrupted or contaminated.

As described, when ISOs have more generation than demand, the extra electricity must be dealt with to maintain the stability of the power grid system. The more renewable energy production, the more likely the prices will be negative, and this is becoming a reality for the ISOs. As mentioned before, the process of controlling these fluctuations is not a straight-forward task and can be difficult to manage in an automatic manner. Renewable contribution can, in fact, damage the grid reliability and stability if not managed appropriately.

Currently, grid operators are dealing with the overgeneration using old techniques and methods, such as a manual technique of switching the automatic control off. Overgeneration caused by renewable resources has created the phenomena in the energy market pricing category of a negative price for electricity (generator owners and energy suppliers are paying the utilities to take extra generated energy off their hands because they cannot find anyone to buy it).

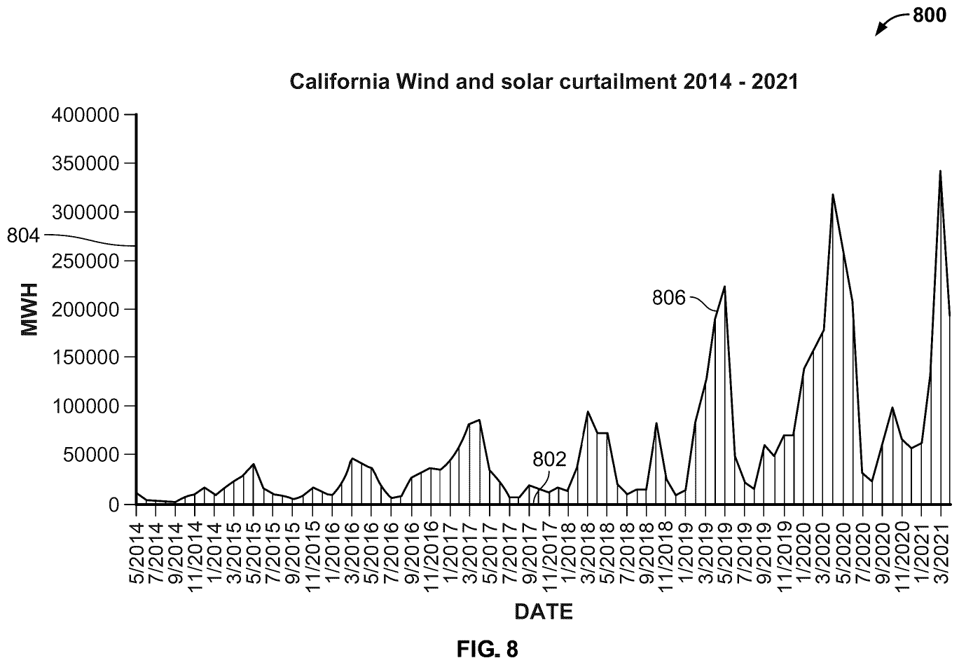

This can lead to renewable curtailment, such as the curtailment of wind and solar shown in FIGS. 8-10. FIG. 8 is an illustration of a graph 800 of renewable energy source curtailment in a power grid over time. In this graph 800, curve 806 represents a summation of wind and solar energy curtailment over time in California from 2014 to 2021. Graph 800 includes x-axis 802 of time (in two month increments from May 2014 to March 2021) and y-axis 804 of energy curtailed, i.e., stopped (in MWh). As shown, curtailment of renewable source generation has increased significantly in this time due, e.g., to negative pricing.

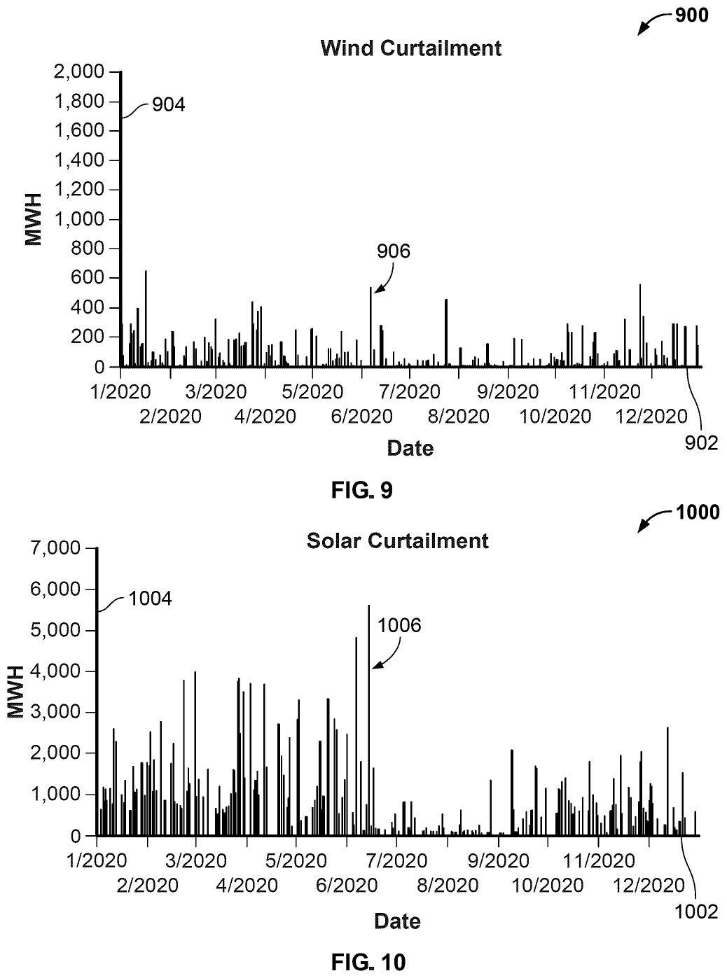

FIG. 9 is an illustration of a graph 900 of wind energy source curtailment in a power grid over time. In this graph 900, curve 906 represents wind energy curtailment over time in California in 2020. Graph 900 includes x-axis 902 of time (in month increments from January 2020 to December 2020) and y-axis 904 of energy curtailed, i.e., stopped (in MWh). As shown, curtailment of wind generation varies significantly each month due, e.g., to negative pricing.

FIG. 10 is an illustration of a graph 1000 of solar energy source curtailment in a power grid over time. In this graph 1000, curve 1006 represents solar energy curtailment over time in California in 2020. Graph 1000 includes x-axis 1002 of time (in month increments from January 2020 to December 2020) and y-axis 1004 of energy curtailed, i.e., stopped (in MWh). As shown, curtailment of solar generation varies significantly each month due, e.g., to negative pricing.

To create a balance, ISOs can intervene to balance the energy generation sources of the power grid. Solar generation may not be as easy to control as the conventional generation (e.g., hydrocarbon generation), so ISOs depend greatly on the classical dispatching of the energy resources. This is easier said than done if there is so much solar overgeneration on the grid. At some point, conventional generation cannot reduce their output to zero and get ready to ramp, especially when solar generation drops greatly, which can happen so many times during the day. The grid was not designed to deal with the solar-wind variable generation, which can swing from maximum generation to minimum generation very quickly many times in a short period of time. The work around is energy curtailment by lowering the production of renewable sources (e.g., wind energy) by adjusting the wind blades to reduce the output. Also, shutting down portions of solar plants is the best controlling measure by controlling the inverters. ISOs have been doing this, but when renewable curtailment happens, ISOs need to calculate the financial losses by the plant owners and compensate the plants. Renewable curtailments increased significantly during the pandemic. For example, in certain months, California (as an example) was forced to drop close to 140,000 MWhs of renewable energy. This curtailment reached about 160,000 MWhs of renewable energy.

Method 200 can continue at step 208, which includes executing an optimization algorithm with the energy dispatch model to minimize at least one objective function. For example, by executing an optimization algorithm with the energy dispatch model, renewable curtailment can be minimized, which can resolve or reduce problems associated with curtailment, such as negative pricing and wasted renewable energy generation. In example aspects, two objective functions can be optimized: a first objective function is operation cost minimization, and a second objective function is maximization of renewable energy source use. The commitment rules and policy are realized in the energy dispatch model to guarantee that renewable energy generators are exploited and put into service while non-fulfilment to achieve the mandatory renewable commitment is penalized in congruence with the renewable commitment structure and framework.

In example implementations of the present disclosure, the energy dispatch model can be adjusted into a single objective problem optimization methodology in order to determine an optimum solution for an explicit and predestined principle or measurement, such as accomplishment of the lowest cost with the combination of this measurement with renewable energy generators contribution to the mix of energy. The optimization problem is to maximize the utilization of renewable energy.

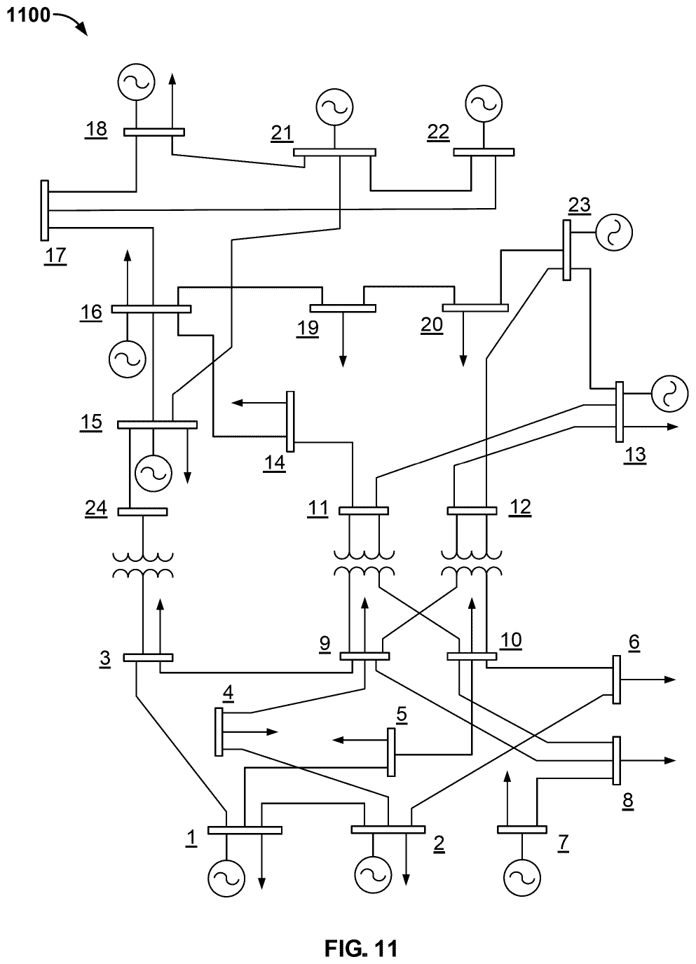

The energy dispatch model can further combine multiple criteria into a single-objective optimization problem by defining the single-objective cost function as a weighted sum of the normalized costs associated with each of the metrics. As an example, FIG. 11 shows an example implementation of an energy dispatch model 1100 using the IEEE RTS 24-Bus model Here, the model is IEEE RTS 24-Bus System for Electricity Market and Power System Operation Studies. This energy dispatch model can be then integrated with a mix of renewable generation and an analysis can be performed to compare a classical dynamic economic dispatch against the energy dispatch model of the present disclosure. Numerical simulations of the comparison demonstrate that the energy dispatch model of the present disclosure is resilient and can acquire and reach high renewable energy source perforation levels.

The optimization/minimization step 208 can execute the following:

$${\sum }_{t ∈ Nt} {\sum }_{s ∈ NS} \{ {( {FC}_{t} )}_{s} {( {X}_{t} )}_{s} + ( Cof ) ( PW ) {( 3 {I}_{t}^{2} {R}_{t} )}_{s} ) \} + {\sum }_{t ∈ N 1} {\sum }_{C ∈ Nc} \{ {( {FC}_{1} )}_{c} {( {X}_{1} )}_{s} + ( Cof ) ( PW ) {( 3 {I}_{1}^{2} {R}_{1} )}_{s} ) \}$$

$$Min ( pg ) [ \begin{matrix}{\sum }_{i = 0}^{NG} ( {a}_{i} + {b}_{i} {P}_{gi} + {c}_{i} {P}_{gi} ) , \\ {\sum }_{i = 0}^{NG} ( {α}_{i} + {β}_{i} {P}_{gi} + δ {iP}_{gi}^{2} )\end{matrix} ] .$$

The overall mathematical form of the dynamic economic dispatch can take the form of:

$$Curt = min {\sum }_{t = 1}^{T} {\sum }_{i = 1}^{N} {cr}_{i} ( {P}_{i}^{t} ) .$$

$${curt}_{i} ( {P}_{i} ) = {a}_{i} + {b}_{i} {P}_{i} + {c}_{i} + ABS ( {d}_{i} * Sin ( {g}_{i} * ( {P}_{i , min} - {P}_{i} ) ) ) ,$$

where curtᵢ(Pᵢ) is the curtailment objective to be minimized.

A sample of the coefficients and parameters can be Σₜ₌₁^{T}Σᵢ₌₁^{N}Pᵢ^{t}=Σₜ₌₁^{T} (P_{D}^{t}+P_{L}^{t}−E_{RS=1}^{M}u_{RS}P_{RS}^{t}.

The cost function for the thermal objective can be:

$$F ( {P}_{ij} ) = \{ {a}_{0 , i} + {\sum }_{j = 1}^{L = n} {a}_{ji} + {P}_{t , i}^{j} + {r}_{i} \} + ABS ( {e}_{i} sin {f}_{i} ( {P}_{i}^{min} - {P}_{i} ) .$$

The cost function for the renewable objective can be:

$$F ( {w}_{ij} ) = {F}_{wi} ( {w}_{ij} ) + {F}_{p , wi} ( {w}_{ij , av} - {w}_{i + j} ) + {F}_{r , wi} ( {w}_{ij} - {w}_{ij , av} ) , where {F}_{r , wi} ( {w}_{ij} - {w}_{ij , av} ) = penalties or fines for not using available wind power generation .$$

The cost function for the emissions objective can be summarized as: Cost Function: Objective Emissions, where greenhouse gasses include Carbon dioxide (CO₂), Thermal NOₓ, Prompt NOₓ, Fuel NOₓ, and Sulfur dioxide (SO₂). Penalties include cost that can be added if a wind power curtailment request was made. The emissions cost function can be defined as:

$$EO ( {P}_{i , 3} ) = {δ}_{3 , i} {P}_{t , i}^{3} + {δ}_{2 , i} {P}_{t , i}^{2} + {δ}_{3 , i} {P}_{t , i}^{3} + {δ}_{0 , i} + {γ}_{3 , i} exp ( {ρ}_{3 , i} {P}_{i} ) + {γ}_{2 , i} .$$

Particular variables in the previous functions include:
(FCₜ)ₛ=Grid/Substations/Cost Investment.
(Xₜ)ₛ=Coefficient per Substation (capacity Limitation).
Cof=Cost factor.
PW=Worth Factor.
(Xt)s=1 if substation t with size s is built.
Nₛ=Size of substation.
N_{c}=Power Lines
T=Time interval period.
NG=Thermal/Traditional generators.
bᵢP_{gi}=The scheduled output power for thermal generator g at time t.
aᵢ, bᵢ, cᵢ=cost coefficients of iₜₕ generating unit.
βᵢ, αᵢ, γᵢ=coefficient of the iₜₕ generating unit emission.

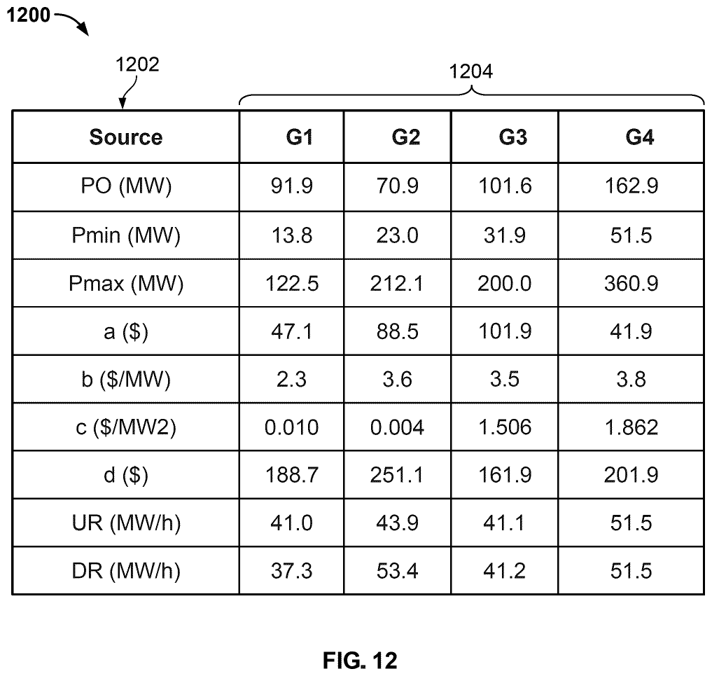

FIG. 12 is a chart 1200 that illustrates coefficients and parameters of the energy dispatch model using the IEEE RTS 24-Bus model according to the present disclosure. The coefficients that can be used in the energy dispatch model are shown in column 1202, while the parameters are shown in columns 1204. Generally, chart 1200 represents four different conventional energy sources 1204 (with columns labeled 1-4) with their respective generation coefficients listed in column 1202. Pminᵢ, and Pmaxᵢ, are the lower and upper bounds of the generation i (in MW). P0ᵢ is the bus real power injection vector by the iₜₕ generation unit at a normal state. URᵢ and DRᵢ are the ramp-up and ramp-down limits of the iₜₕ generator and are specified in terms of the rate at which it can increase or decrease its power output, measured in megawatts per time period. Cost coefficients of the iₜₕ generator are aᵢ ($/MW), bᵢ($/MW), and cᵢ ($/MW).

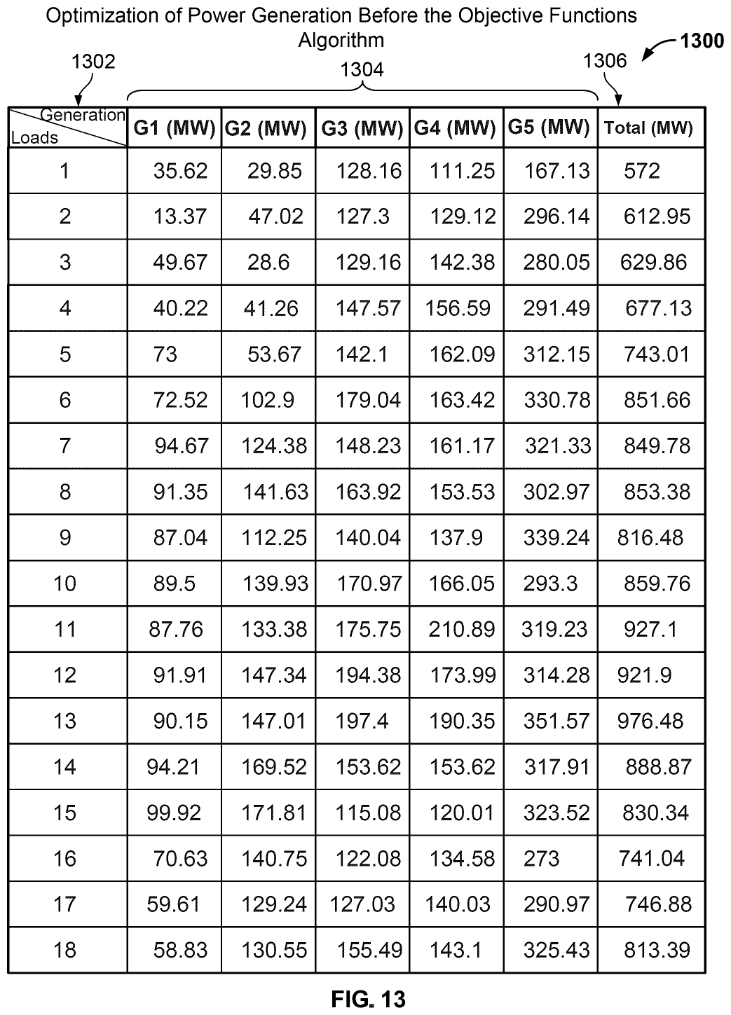

FIG. 13 is a chart 1300 that illustrates an output of an optimal energy dispatch algorithm with renewable energy source integration independent of objective function optimization according to the present disclosure. Chart 1300 includes column 1302 which shows loads or grid nodes, and columns 1304 that represent power generation (in MWh) different energy generation sources. Column 1306 represents a total energy generation (in MWh). Generally, the sources shown in columns 1304 include G1, G2, G3, and G4, which are conventional power generation sources, while G5 is a wind power plant with a commitment to renewable energy. The column 1302 lists the loads or grid nodes, with a total of 18 nodes. Each row in chart 1300 represents a power output of individual generators (G1 through G5) that supply a specific load or grid node. G5 refers to the power created by a wind plant. The numerical results in the rows in chart 1300 show the limitations imposed on wind energy production without any corrective measures. As a result, a significant amount of wind energy is not utilized due to curtailment.

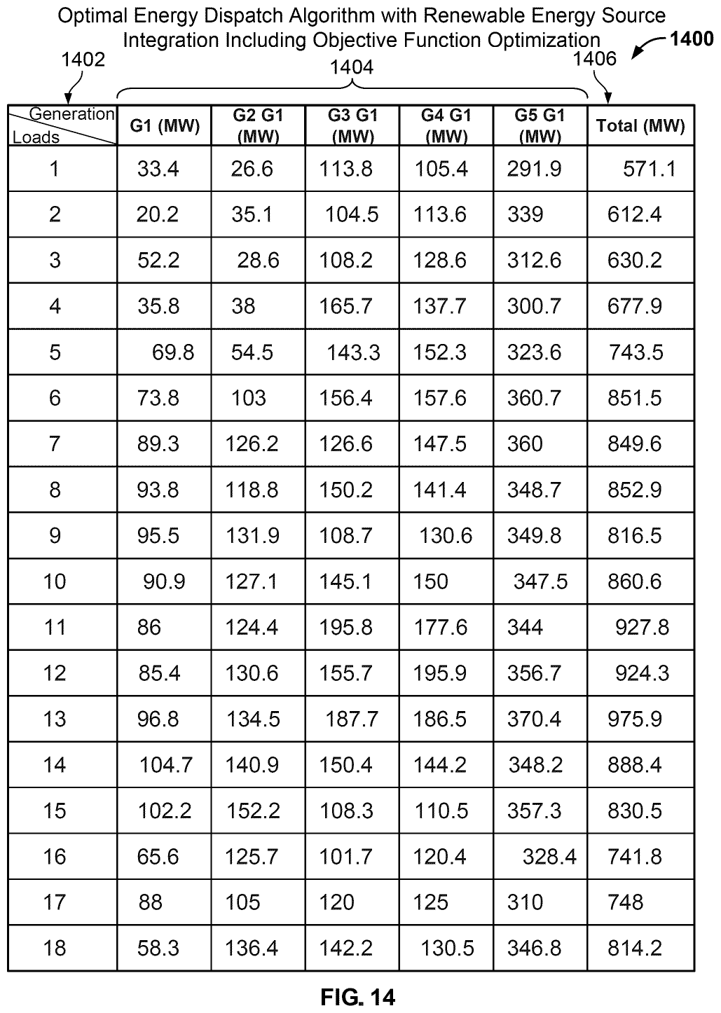

FIG. 14 is a chart 1400 that illustrates an output of an optimal energy dispatch algorithm with renewable energy source integration including objective function optimization according to the present disclosure. Chart 1400 includes column 1402 which shows loads or grid nodes, and columns 1404 that represent power generation (in MWh) different energy generation sources. Column 1406 represents a total energy generation (in MWh). Generally, the sources shown in columns 1404 include G1, G2, G3, and G4, which are conventional power generation sources, while G5 is a wind power plant with a commitment to renewable energy. The column 1402 lists the loads or grid nodes, with a total of 18 nodes. Each row in chart 1400 represents a power output of individual generators (G1 through G5) that supply a specific load or grid node. G5 refers to the power created by a wind plant. The numerical results in the rows in chart 1400 indicate wind constraints with the corrective objective, which results in more utilization of power generated by the wind plant, reduced curtailment of renewable energy sources, and optimization of the use of classical generation. The power generated by wind plant (G5) in chart 1400 represents wind constraints with the correction objective, resulting in more use of power generated by the wind plant instead of curtailment. Thus, less renewable curtailment is possible by optimizing the use of thermal generation.

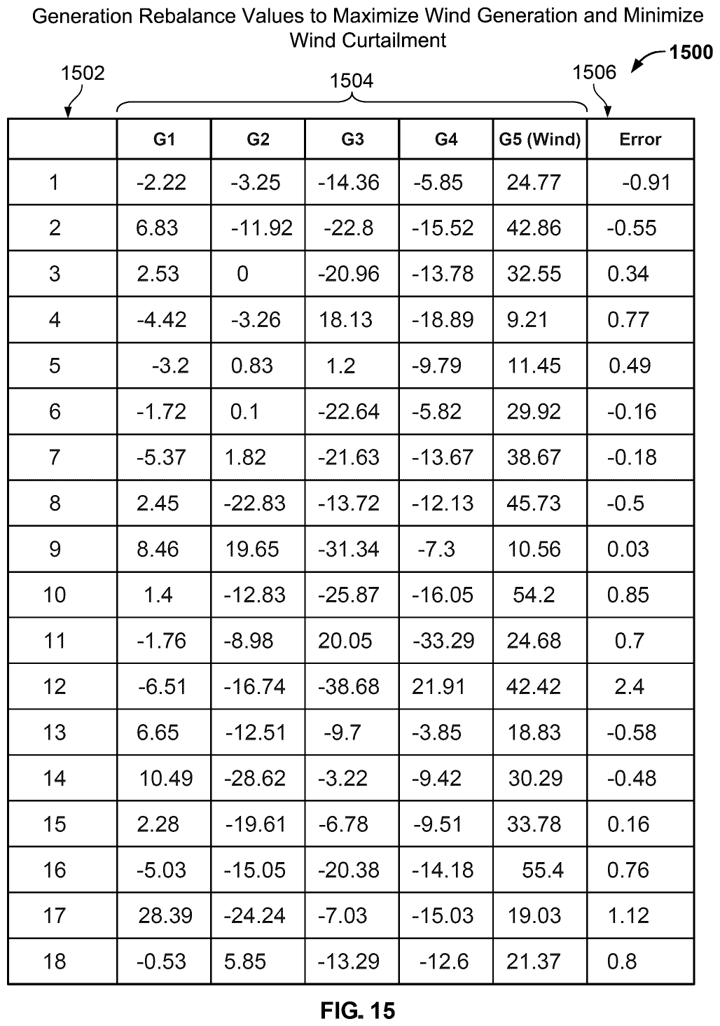

FIG. 15 is a chart 1500 that illustrates generation rebalance values to maximize wind generation and minimize wind curtailment based on the outputs of FIGS. 13 and 14 according to the present disclosure. Chart 1500 includes column 1502 which shows loads or grid nodes, and columns 1504 that represent power generation (in MWh) of different energy generation sources (with G5 representing the wind generation). Column 1506 represents calculation error. Generally, this chart 1500 shows a source generation rebalance to maximize wind generation and minimize wind curtailment using the objective function optimization of step 208.

The optimization constrains can also include the following renewable, thermal, and congestion constraints:

G=Σᵢ₌₁ⁿGᵢⱼ+Σᵢ₌₁^{w}Gwᵢⱼ+Σᵢ₌₁^{s}GVᵢⱼ=G_{Dj}^{a}+Gₗₒₛⱼ, which checks for combined constraints.

$${G}_{r} [ {\sum }_{i}^{n} {G}_{im} + ϑ ( {w}_{ij} + {GV}_{ij} ) ] \leq {G}_{Dj}^{a} + {G}_{losj} \leq {G}_{a}$$

$${G}_{D}^{a} = {G}_{D}^{t} - ( {GV}_{ij , av} + {w}_{ij , av} ) \pm {G}_{R}$$

$${G}_{r} \leq {( {GV}_{ij , av} + {w}_{ij , av} )}_{g} - {( {GV}_{ij} + {w}_{ij} )}_{d}$$

$${( {GV}_{ij} + {w}_{ij} )}_{d} \leq {xG}_{D}^{a}$$

The cost of wind curtailment:

$${G}_{r} \leq σ {\sum }_{{T}_{a}} {( {GV}_{ij , av} + {w}_{ij , av} )}_{g} - {( {GV}_{ij} + {w}_{ij} )}_{d}$$

$${\sum }_{{T}_{u}} {G}_{r} \leq {\sum }_{{T}_{a}} {G}_{r}$$

Particular variables in the previous functions include:
wᵢⱼ=Wind generated Power Scheduled output.
VDERᵢⱼ=Other Renewable Power Scheduled output.
i^{th}=Wind Generator Number.
j^{th}=Determined Operation Hour.
G=Cost Function.
Pᵢⱼ=Traditional Power Scheduled Output.
Gₗₒₛⱼ=Line Losses at Determined Operation Hour.
G_{Dj}^{a}=Actual Demand Distributed (Generating Units, Operation Hour).
G_{R}=Stored Power on The Grid.
Gₐ=All Contribution Renewable Power.
G_{D}^{t}=Total Power Demand.
GV_{ij,av}+w_{ij,av}=Deducted Power.
ϑ, σ Cost Coefficients.

Method 200 can continue at step 210, which determining at least one energy system control command based on the executed optimization model. For example, based on the executed optimization model, energy system control commands can include increasing or decreasing an amount of power generated by a particular energy generation source, including one or more renewable energy generation sources.

Method 200 can continue at step 212, which includes controlling the multiple energy generation resources to maximize a power output of the at least one renewable energy source based on the executed energy dispatch model. For example, the executed energy dispatch model output (and control command) can control the energy generation sources of a power grid to maximize renewable energy generation and minimize curtailment of renewable energy generation (e.g., by operating thermal resources at a minimal generation capacity at certain times).

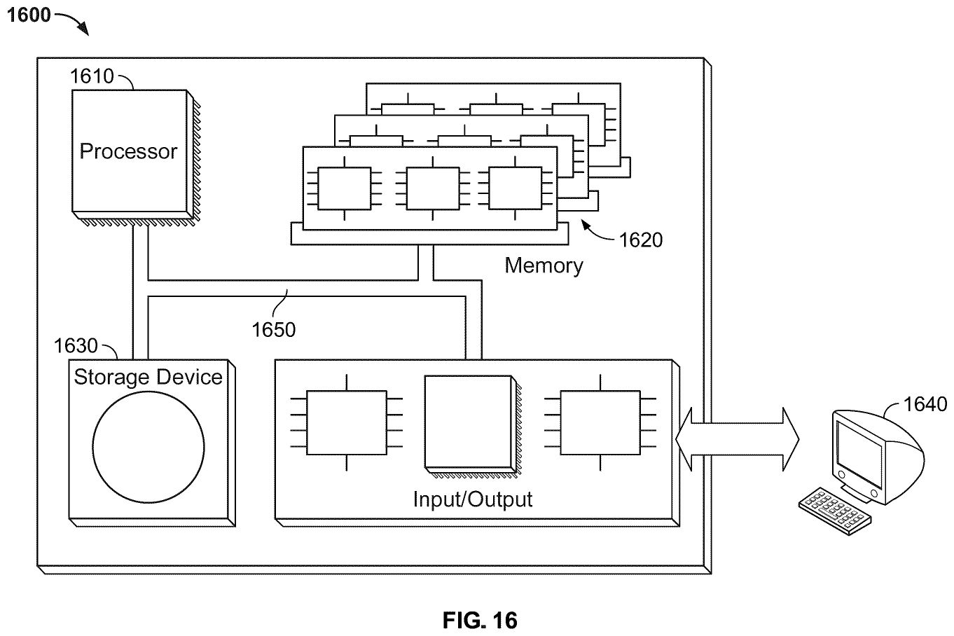

FIG. 16 shows a schematic drawing of a control system 1600 that can be used to build and execute an energy dispatch model according to the present disclosure and/or any processes described in the present disclosure, such as method 200. Some or all of the example control system 1600 can be implemented as cloud-based system and/or service, alone or in combination with other portions of the example control system 1600. The controller 1600 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1600 includes a processor 1610, a memory 1620, a storage device 1630, and an input/output device 1640. Each of the components 1610, 1620, 1630, and 1640 are interconnected using a system bus 1650. The processor 1610 is capable of processing instructions for execution within the controller 1600. The processor may be designed using any of a number of architectures. For example, the processor 1610 may be a CISC (Complex Instruction Set Computers) processor, a RISC (Reduced Instruction Set Computer) processor, or a MISC (Minimal Instruction Set Computer) processor.

In one implementation, the processor 1610 is a single-threaded processor. In another implementation, the processor 1610 is a multi-threaded processor. The processor 1610 is capable of processing instructions stored in the memory 1620 or on the storage device 1630 to display graphical information for a user interface on the input/output device 1640.

The memory 1620 stores information within the control system 1600. In one implementation, the memory 1620 is a computer-readable medium. In one implementation, the memory 1620 is a volatile memory unit. In another implementation, the memory 1620 is a non-volatile memory unit.

The storage device 1630 is capable of providing mass storage for the controller 1600. In one implementation, the storage device 1630 is a computer-readable medium. In various different implementations, the storage device 1630 may be a floppy disk device, a hard disk device, an optical disk device, a tape device, flash memory, a solid state device (SSD), or a combination thereof.

The input/output device 1640 provides input/output operations for the controller 1600. In one implementation, the input/output device 1640 includes a keyboard and/or pointing device. In another implementation, the input/output device 1640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A computer-implemented method of managing a power grid, comprising:
identifying, with a control system comprising one or more hardware processors, a plurality of energy generation resources electrically coupled within a power grid;
identifying, with the control system, at least one renewable energy source within the plurality of energy generation resources electrically coupled within the power grid;
inputting, with the control system, grid and energy source data from the identified plurality of energy generation resources into an energy dispatch model;
executing, with the control system, an optimization algorithm with the energy dispatch model to optimize at least one objective function;
determining, with the control system, at least one energy system control command based on the executed optimization model; and
controlling, with the control system, the plurality of energy generation resources to maximize a power output of the at least one renewable energy source based on the executed energy dispatch model.

2. The computer-implemented method of claim 1, wherein controlling the multiple energy generation resources to maximize the power output of the at least one renewable energy source based on the executed energy dispatch model comprises controlling, with the control system, the multiple energy generation resources to minimize curtailment of the at least one renewable energy source based on the executed energy dispatch model.

3. The computer-implemented method of claim 2, wherein the at least one renewable energy source comprises a wind energy source.

4. The computer-implemented method of claim 1, wherein the energy dispatch model comprises an IEEE RTS 24-Bus model.

5. The computer-implemented method of claim 1, wherein executing the optimization algorithm with the energy dispatch model to optimize at least one objective function comprises:
executing, with the control system, the optimization algorithm with the energy dispatch model to minimize an operational cost function; and
executing, with the control system, the optimization algorithm with the energy dispatch model to maximize a usage of the at least one renewable energy source function.

6. The computer-implemented method of claim 1, wherein the operational cost function comprises a thermal energy operational cost function, a renewable energy operational cost function, and an emissions operational cost function.

7. The computer-implemented method of claim 1, wherein the grid and energy source data comprise wind forecast systems data, auto load forecast data, distributed wind energy data, thermal energy generation data, auxiliary energy generation data, and aggregated energy generation data.

8. A computing system, comprising:
one or more memory modules configured to store an energy dispatch model of a power grid; and
one or more hardware processors communicably coupled to the one or more memory modules and configured to execute instructions stored on the one or more memory modules to perform operations comprising:
identifying a plurality of energy generation resources electrically coupled within a power grid;
identifying at least one renewable energy source within the plurality of energy generation resources electrically coupled within the power grid;
inputting grid and energy source data from the identified plurality of energy generation resources into the energy dispatch model;
executing an optimization algorithm with the energy dispatch model to optimize at least one objective function;
determining at least one energy system control command based on the executed optimization model; and
controlling the plurality of energy generation resources to maximize a power output of the at least one renewable energy source based on the executed energy dispatch model.

9. The computing system of claim 8, wherein the operation of controlling the multiple energy generation resources to maximize the power output of the at least one renewable energy source based on the executed energy dispatch model comprises controlling the multiple energy generation resources to minimize curtailment of the at least one renewable energy source based on the executed energy dispatch model.

10. The computing system of claim 9, wherein the at least one renewable energy source comprises a wind energy source.

11. The computing system of claim 8, wherein the energy dispatch model comprises an IEEE RTS 24-Bus model.

12. The computing system of claim 8, wherein the operation of executing the optimization algorithm with the energy dispatch model to optimize at least one objective function comprises:
executing the optimization algorithm with the energy dispatch model to minimize an operational cost function; and
executing the optimization algorithm with the energy dispatch model to maximize a usage of the at least one renewable energy source function.

13. The computing system of claim 8, wherein the operational cost function comprises a thermal energy operational cost function, a renewable energy operational cost function, and an emissions operational cost function.

14. The computing system of claim 8, wherein the grid and energy source data comprise wind forecast systems data, auto load forecast data, distributed wind energy data, thermal energy generation data, auxiliary energy generation data, and aggregated energy generation data.

15. An apparatus comprising a tangible, non-transitory computer readable memory comprising instructions for causing one or more processors to perform operations comprising:
identifying a plurality of energy generation resources electrically coupled within a power grid;
identifying at least one renewable energy source within the plurality of energy generation resources electrically coupled within the power grid;
inputting grid and energy source data from the identified plurality of energy generation resources into the energy dispatch model;
executing an optimization algorithm with the energy dispatch model to optimize at least one objective function;
determining at least one energy system control command based on the executed optimization model; and
controlling the plurality of energy generation resources to maximize a power output of the at least one renewable energy source based on the executed energy dispatch model.

16. The apparatus of claim 15, wherein the operation of controlling the multiple energy generation resources to maximize the power output of the at least one renewable energy source based on the executed energy dispatch model comprises controlling the multiple energy generation resources to minimize curtailment of the at least one renewable energy source based on the executed energy dispatch model.

17. The apparatus of claim 16, wherein the at least one renewable energy source comprises a wind energy source.

18. The apparatus of claim 15, wherein the energy dispatch model comprises an IEEE RTS 24-Bus model.

19. The apparatus of claim 15, wherein the operation of executing the optimization algorithm with the energy dispatch model to optimize at least one objective function comprises:
executing the optimization algorithm with the energy dispatch model to minimize an operational cost function; and
executing the optimization algorithm with the energy dispatch model to maximize a usage of the at least one renewable energy source function.

20. The apparatus of claim 15, wherein the operational cost function comprises a thermal energy operational cost function, a renewable energy operational cost function, and an emissions operational cost function.

21. The apparatus of claim 15, wherein the grid and energy source data comprise wind forecast systems data, auto load forecast data, distributed wind energy data, thermal energy generation data, auxiliary energy generation data, and aggregated energy generation data.
